(19) United States
(12) Patent Application Publication
(10) Pub. No.: US 2009/0241430 A1
(43) Pub. Date: Oct. 1, 2009

(54) SEAL ARRANGEMENT

(75) Inventor: Ruediger Knape, Salzgitter (DE)

Correspondence Address: FOX ROTHSCHILD LLP, 2000 MARKET STREET, 10th Floor, PHILADELPHIA, PA, 19103, US

(73) Assignee: METEOR GUMMIWERKE K.H. BADJE GMBH & CO. KG, Bockenem (DE)

(21) Appl. No.: 12/373,443

(22) PCT Filed: Feb. 15, 2007
(86) PCT No.: PCT/EP2007/001305

§ 371 Date: Jan. 12, 2009

(30) Foreign Application Priority Data
Jul. 12, 2006 (DE) 20 2006 010 859.9

(51) Int. Cl. B60J 10/04; E06B 7/16

(52) U.S. Cl. 49/489.1; 49/490.1

(57) ABSTRACT

A seal arrangement consists of a U-shaped reception profile (1), the base side of which is designed to be fastened to a body part, and of an attachment profile (4) which has a U-shaped holding part (17) which is attached onto one leg (3) of the reception profile (1). The reception profile (1) forms a reception space (6) for bordering a pane (42), which reception space is delimited by hollow profile parts (10, 18) which lie opposite one another and are intended for bearing sealingly against the pane (42) and which are integrally formed in each case on the reception profile (1) and on the attachment profile (4). With the pane (42) moved out of the reception space (6), the hollow profile parts (10, 18) bear under elastic prestress one against the other. The attachment part (4) can be mounted and demounted independently of the reception part, so that the reception profile (1) can be utilized for the exact positioning of the seal arrangement as a whole.

The invention relates to a seal arrangement according to the preamble of claim 1.

Seal arrangements of this type are used comprehensively in vehicles in connection, for example, with drip moldings, window guide beads and other door seals. In this capacity, they should be mountable in a simple and reliable way, have a stable mounting position, exhibit sufficient adaptability to the shape of the generally three-dimensionally curved structure of a displaceably mounted window pane, so as to ensure a uniform sealing force, and, furthermore, be capable of being produced cost-effectively. In addition to this, there are requirements relating to material properties, such as strength, rigidity, surface properties, the visual appearance, insensitivity to environmental influences, etc. It is difficult to fulfill all these requirements optimally, and special measures are always necessary for this purpose.

It is known to fulfill these requirements by producing the seal arrangement in multipart form and from different materials.

Thus, the literature reference DE 30 36 058 discloses a two-part seal arrangement, in which a reception profile of U-shaped cross section, which can be attached onto an edge flange of a body part of a motor vehicle and consists on the outside of a foamed plastic and on the inside of a nonfoamed plastic, can be connected to an attachment profile which can be placed onto one of the two legs of this profile and which consists of a rubber material. The reception profile and, likewise, the U-shaped portion, intended to be attached onto this, of the attachment profile, on which a plurality of sealing lips are integrally formed, are equipped with a metallic reinforcement. An essential reason for the two-part configuration of this seal arrangement is the different processing properties of the materials used in the two components, said processing properties ruling out, for example a joint forming operation. This seal arrangement is intended to cooperate with a window plane slideably guided between a closing and an opening position, and is correspondingly provided with a U-shaped reception space in which the pane is received in the closed state. The reception space is formed partially by portions of the attachment profile and partially by portions of the reception profile, which portions in each case form on the inside sealing lips which are intended and set up to bear against the pane. For further stabilization, the attachment profile is provided with a intended for receiving a strip-like metallic stiffening element. After the attachment profile is connected to the reception profile by means of U-shaped reception portion oriented conversely to the reception profile, the entire seal arrangement can in actual fact be mounted and demounted only in one piece.

A multipart seal arrangement is known from literature reference U.S. Pat. No. 6,485,663, in which is provided a reception profile which consists of thermoplastic elastomer (TPE) and has a first U-shaped profile portion, intended to be attached onto an edge flange of a body part, and a second U-shaped profile portion, intended for receiving a U-shaped sealing profile consisting of ethylene/propylene-diene terpolymer (EPDM). With regard to the reception profile, differently conditioned thermoplastic elastomers are used, which differ from one another in terms of their elasticity, so that, on the one hand, if necessary, sufficient deformability during mounting along small radii of curvature and, on the other hand, at least locally, sufficient rigidity are provided, with the result that no reinforcing elements are necessary. The profile portion intended to be attached onto the edge flange is overlaid by a cover strip which consists of TPE and on which a sealing lip is integrally formed. Said sealing profile is secured positively within said profile portion and surrounds a reception space, into which a slideably guided window pane of a vehicle can be introduced in the closed state, specifically so as to bear sealingly on both sides against confronting sealing lip-like structural elements of the sealing profile. This is, therefore, a seal arrangement which, overall, is in three parts.

Literature reference DE 197 39 555 discloses a seal arrangement which consists of a fastening frame, formed from plastic or metal and securable to a body part at points spaced apart from one another, and of two sealing elements separated from one another and connectable to the fastening frame. One sealing element has a U-shaped holding part provided with a reinforcement and is attached onto a side portion of the fastening frame, in this case at the same time surrounding a body part, whereas the other sealing element is inserted via a web-like holding portion into a channel-like receptacle of the fastening portion. A U-shaped reception space, into which a pane can be introduced in the closed state and undergoes on both sides an approximately uniform sealing action, is afforded to only a greater restricted extent in this seal arrangement.

Literature reference DE 195 31 600 discloses a one-piece seal arrangement which is to be fastened to two body parts spaced apart from one another and which forms a U-shaped reception space for a pane in the closed state of the latter. Sealing lips, which are integrally formed on the free ends of the side portions of the reception space, come to bear on both sides of the pane.

Literature reference DE 10 2004 004 053 discloses a two-part seal arrangement which consists of two sealing elements connectable separately and independently of one another to body parts and which forms a reception space for a pane in the closed state of the latter. One of the sealing elements can be screwed to a body part, whereas the other sealing element can be attached via a U-shaped holding portion onto a web-like body part. Hollow-profile-like sealing lips are integrally formed on both sealing elements.

A further one-piece seal arrangement is known from literature reference EP 1 273 472, in which a rail-like carrier body consisting of metal or plastic is provided, the free ends of which are characterized by sealing elements which are firmly connected to the carrier body and are integrally formed on the latter via an injection molding process.

A seal arrangement is known from literature reference EP 0 420 617, which consists of an elastomeric holding portion which is designed for use in a door border and which for the most part surrounds a U-shaped reinforcement, on the free ends of which sealing elements, such as, for example, sealing lips, or else hollow profile elements are integrally formed. The sealing elements are composed of different plastics, and a U-shaped reception space designed for receiving a pane is defined, the sealing elements being intended to bear sealingly against the pane on both sides. This known seal arrangement may be produced in a molding die and is designed as a one-piece seal which can correspondingly also only be mounted or demounted as a unit.

Literature reference EP 0 872 369 discloses a further seal arrangement which forms a U-shaped reception space for the pane of the window in a vehicle door. The seal arrangement is of two-part design and consists of a first part which can be attached onto a door rebate and forms a U-shaped fastening portion which also extends partially in the bottom region of the reception space and at its free end forms a latching portion with a second part, so that each of the two parts constitutes one side leg of the U-shaped reception space. The two parts are provided on their mutually confronting sides with hollow-profile-like sealing elements which project into the reception space and are intended to bear sealingly against the pane. To fasten the second part, an angle-like supporting element attached to body parts or else a plate is provided. Moreover, the two parts are equipped independently of one another with reinforcing inserts. To mount such a seal arrangement, therefore, special measures in the region of the vehicle doors, to be precise a door rebate, and, furthermore, a further supporting element are required. Finally, EP 0 799 748 discloses a strip arrangement, which is a cover strip which is intended for covering the connection region of two body parts and consists substantially of a holding profile and of a cover profile. The holding profile is formed in two parts, the parts being adhesively bonded to one of said body parts. These parts consist in each case of rubber materials of different hardness and are connected to one another via a joint portion which is configured as a relatively thin-walled portion of the same material. The cover profile, for example a trim strip, is secured positively to the holding profile. As a result of said design of the holding profile, there is the possibility of compensating deviations in position of the two body parts, without the visual appearance of the mounted trim strip being impaired.

One-piece seal arrangements have disadvantages insofar as, in the event of damage, the entire seal arrangement always has to be discarded and replaced by a new one. Seal arrangements, in which, for example, two fastening regions are required transversely to their longitudinal extent which therefore consist of two parts mounted independently of one another have disadvantages in as much as special installation conditions or preparatory measures have to be provided on the body so that they can be adapted to it. This may restrict use when these preconditions are not afforded or are afforded to only a limited extent. Where there are two fastening regions, the exact positioning of the two parts of the seal arrangement may also sometimes be relatively complicated.

### DESCRIPTION

### Seal Arrangement

The invention relates to a seal arrangement according to the preamble of claim 1.

Seal arrangements of this type are used comprehensively in vehicles in connection, for example, with drip moldings, window guide beads and other door seals. In this capacity, they should be mountable in a simple and reliable way, have a stable mounting position, exhibit sufficient adaptability to the shape of the generally three-dimensionally curved structure of a displaceably mounted window pane, so as to ensure a uniform sealing force, and, furthermore, be capable of being produced cost-effectively. In addition to this, there are requirements relating to material properties, such as strength, rigidity, surface properties, the visual appearance, insensitivity to environmental influences, etc. It is difficult to fulfill all these requirements optimally, and special measures are always necessary for this purpose.

It is known to fulfill these requirements by producing the seal arrangement in multipart form and from different materials.

Thus, the literature reference DE 30 36 058 discloses a two-part seal arrangement, in which a reception profile of U-shaped cross section, which can be attached onto an edge flange of a body part of a motor vehicle and consists on the outside of a foamed plastic and on the inside of a nonfoamed plastic, can be connected to an attachment profile which can be placed onto one of the two legs of this profile and which consists of a rubber material. The reception profile and, likewise, the U-shaped portion, intended to be attached onto this, of the attachment profile, on which a plurality of sealing lips are integrally formed, are equipped with a metallic reinforcement. An essential reason for the two-part configuration of this seal arrangement is the different processing properties of the materials used in the two components, said processing properties ruling out, for example a joint forming operation. This seal arrangement is intended to cooperate with a window plane slideably guided between a closing and an opening position, and is correspondingly provided with a U-shaped reception space in which the pane is received in the closed state. The reception space is formed partially by portions of the attachment profile and partially by portions of the reception profile, which portions in each case form on the inside sealing lips which are intended and set up to bear against the pane. For further stabilization, the attachment profile is provided with a [lacuna] intended for receiving a strip-like metallic stiffening element. After the attachment profile is connected to the reception profile by means of U-shaped reception portion oriented conversely to the reception profile, the entire seal arrangement can in actual fact be mounted and demounted only in one piece.

A multipart seal arrangement is known from literature reference U.S. Pat. No. 6,485,663, in which is provided a reception profile which consists of thermoplastic elastomer (TPE) and has a first U-shaped profile portion, intended to be attached onto an edge flange of a body part, and a second U-shaped profile portion, intended for receiving a U-shaped sealing profile consisting of ethylene/propylene-diene terpolymer (EPDM). With regard to the reception profile, differently conditioned thermoplastic elastomers are used, which differ from one another in terms of their elasticity, so that, on the one hand, if necessary, sufficient deformability during mounting along small radii of curvature and, on the other hand, at least locally, sufficient rigidity are provided, with the result that no reinforcing elements are necessary. The profile portion intended to be attached onto the edge flange is overlaid by a cover strip which consists of TPE and on which a sealing lip is integrally formed. Said sealing profile is secured positively within said profile portion and surrounds a reception space, into which a slideably guided window pane of a vehicle can be introduced in the closed state, specifically so as to bear sealingly on both sides against confronting sealing lip-like structural elements of the sealing profile. This is, therefore, a seal arrangement which, overall, is in three parts.

DE 197 39 555 discloses a seal arrangement which consists of a fastening frame, formed from plastic or metal and securable to a body part at points spaced apart from one another, and of two sealing elements separated from one another and connectable to the fastening frame. One sealing element has a U-shaped holding part provided with a reinforcement and is attached onto a side portion of the fastening frame, in this case at the same time surrounding a body part, whereas the other sealing element is inserted via a web-like holding portion into a channel-like receptacle of the fastening portion. A U-shaped reception space, into which a pane can be introduced in the closed state and undergoes on both sides an approximately uniform sealing action, is afforded to only a greater restricted extent in this seal arrangement.

DE 195 31 600 discloses a one-piece seal arrangement which is to be fastened to two body parts spaced apart from one another and which forms a U-shaped reception space for a pane in the closed state of the latter. Sealing lips, which are integrally formed on the free ends of the side portions of the reception space, come to bear on both sides of the pane.

DE 10 2004 004 053 discloses a two-part seal arrangement which consists of two sealing elements connectable separately and independently of one another to body parts and which forms a reception space for a pane in the closed state of the latter. One of the sealing elements can be screwed to a body part, whereas the other sealing element can be attached via a U-shaped holding portion onto a web-like body part. Hollow-profile-like sealing lips are integrally formed on both sealing elements.

A further one-piece seal arrangement is known from EP 1 273 472, in which a rail-like carrier body consisting of metal or plastic is provided, the free ends of which are characterized by sealing elements which are firmly connected to the carrier body and are integrally formed on the latter via an injection molding process.

Finally, EP 0 799 748 discloses a strip arrangement, which is a cover strip which is intended for covering the connection region of two body parts and consists substantially of a holding profile and of a cover profile. The holding profile is formed in two parts, the parts in each case being adhesively bonded to one of said body parts. These parts consist in each case of rubber materials of different hardness and are connected to one another via a joint portion which is configured as a relatively thin-walled portion of the same material. The cover profile, for example a trim strip, is secured positively to the holding profile. As a result of said design of the holding profile, there is the possibility of compensating deviations in position of the two body parts, without the visual appearance of the mounted trim strip being impaired.

One-piece seal arrangements have disadvantages insofar as, in the event of damage, the entire seal arrangement always has to be discarded and replaced by a new one. Seal arrangements, in which, for example, two fastening regions are required transversely to their longitudinal extent which therefore consist of two parts mounted independently of one another have disadvantages in as much as special installation conditions or preparatory measures have to be provided on the body so that they can be adapted to it. This may restrict use when these preconditions are not afforded or are afforded to only a limited extent. Where there are two fastening regions, the exact positioning of the two parts of the seal arrangement may also sometimes be relatively complicated.

Against this background, the object of the invention is to configure a seal arrangement of the type initially designated with a view to increased flexibility, which at the same time can be handled in a simple way in mounting terms, has stable and reproducible operating properties and can be produced simply. This object is achieved, in such a seal arrangement, by means of the features of the characterizing part of claim 1.

The structural elements intended for the pane to come to bear sealingly are formed by hollow profile parts which extend from the inside of the reception space of U-shaped cross section. Depending on the actual shape of the reception profile or of the attachment profile, the hollow profile parts may be integrally formed either on one of these two profiles or on the other. However, one hollow profile part may be integrally formed on the reception profile and the other hollow part on the attachment profile. These hollow profile parts afford diverse configuration possibilities for setting the sealing force taking effect between these and the pane. It is essential that fastening to body parts is provided via the reception profile, specifically via its base side, so that the reception profile forms an open top side, thus making it possible to attach the attachment profile onto a leg of the reception profile. This means that the attachment profile can be mounted and demounted independently of the reception profile. This affords the possibility of using the reception profile for the exact positioning of the seal arrangement, so that, with the reception profile mounted, the attachment profile can be exchanged in a simple way. This may be advantageous in the event of wear, but it also offers simple ways of varying the visible appearance of the seal arrangement, as required.

According to the features of claims 2 and 3, the reception profile and the attachment profile consist of an elastomer into which a reinforcement is incorporated. The reinforcement consists of a metal, for example steel or stainless steel, or, alternatively, of a hard thermoplastic, such as, for example, TPE, and, in the case of the reception profile, preferably extends over the essential part of its U-shaped cross section. The attachment profile is provided with a holding part which serves for the preferably positive fastening to the reception profile, and the reinforcement of the reception profile extends, for example, along the essential part of the cross section of the holding part. This reinforcement, too, may also consist of a metal, for example steel or stainless steel, or of a hard thermoplastic, such as, for example, TPE. By means of the reinforcements, in addition to an increase in strength, an improvement in rigidity is achieved, so that a pressing action between surfaces lying against one another can be increased. An elastomer which comes under consideration is a soft rubber, microcellular rubber or a thermoplastic elastomer. Both the reception profile and the attachment profile can be produced cost-effectively by the extrusion method.

According to the features of claim 4, the reception profile is intended to be screwed to body parts. This, in conjunction with long holes in the body parts, affords possibilities of adjustment parallel to the body parts and, in conjunction with washers, possibilities of adjustment perpendicularly to the plane of the body parts.

The features of claims 5 and 6 are directed at the further configuration of said hollow profile parts. For a reduction in friction and in wear, the portions bearing directly against the pane either may have a special surface coating, for example lacquer, flock or laminating tape, or may consist locally of a material having a harder conditioning, as compared with the material of the remaining parts of the reception profile or of the attachment profile.

The holding part of the attachment profile is designed according to the features of claim 7 and to be attached onto the inside leg of the reception profile.

The features of claims 8 and 9 are directed at a configuration of that side of the reception profile which is intended to constitute the outside of a vehicle. On this side, a channel is integrally formed, which serves for the diversion of rainwater. Furthermore, a sealing lip intended to bear against the body parts is integrally formed on this channel.

The features of claims 10 and 11 are directed at a configuration of the attachment profile intended to constitute the inside of the vehicle. On its side confronting the inside of the vehicle, a further hollow profile part is integrally formed, which is intended to bear against a component within the vehicle, for example an inside roof lining. This hollow profile part serves as a cosmetic element of the interior design of a vehicle. The U-shaped holding part is provided on the inside with elastically deformable retention elements which are intended for cooperating with said leg of the reception profile and the retention action of which is intensified by the reinforcement, likewise mentioned.

Those portions of the hollow profile parts which project into the reception space may be designed according to the features of claim 12, with a view to providing a defined elastic deformation behavior. In practice, this may be achieved by means of corresponding wall thickness dimensioning, by means of locally soft conditioned material regions or else by means of notches, the shape of the walls, etc.

The invention is explained in more detail below with reference to the exemplary embodiment of a seal arrangement which is reproduced diagrammatically in the drawings in which:

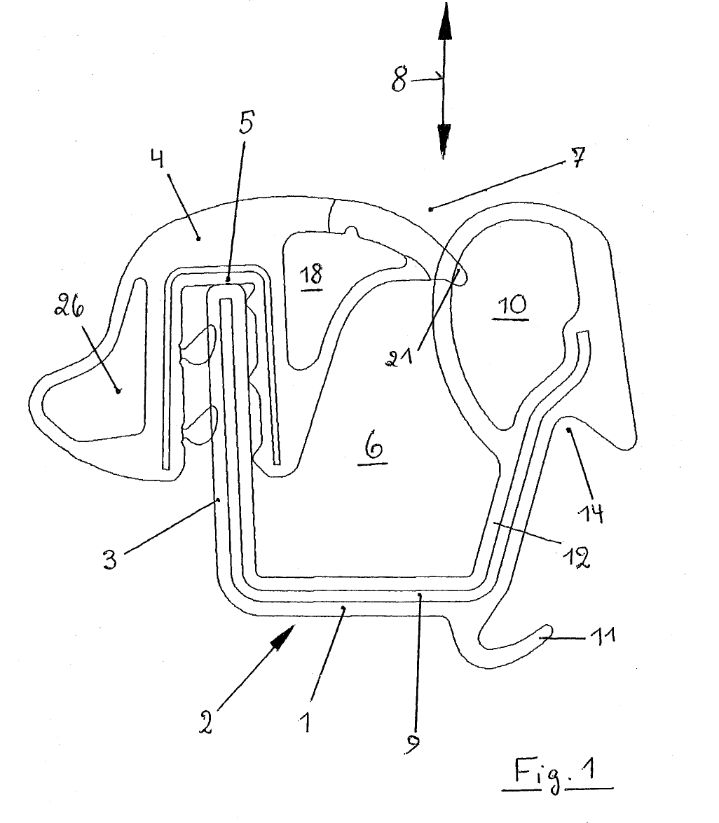

FIG. 1 shows an isolated illustration of an exemplary embodiment of the seal arrangement according to the invention in cross section;

FIG. 2 shows an isolated illustration of a reception profile, as part of the seal arrangement according to FIG. 1, in cross section;

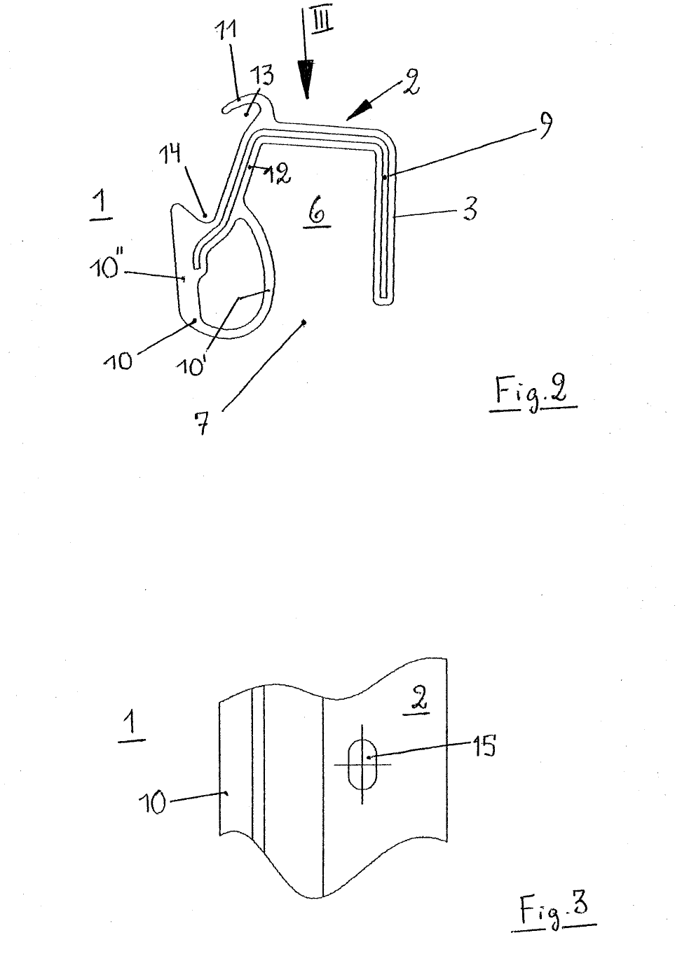

FIG. 3 shows an illustration of an underside view of the reception profile in the viewing direction III of FIG. 2;

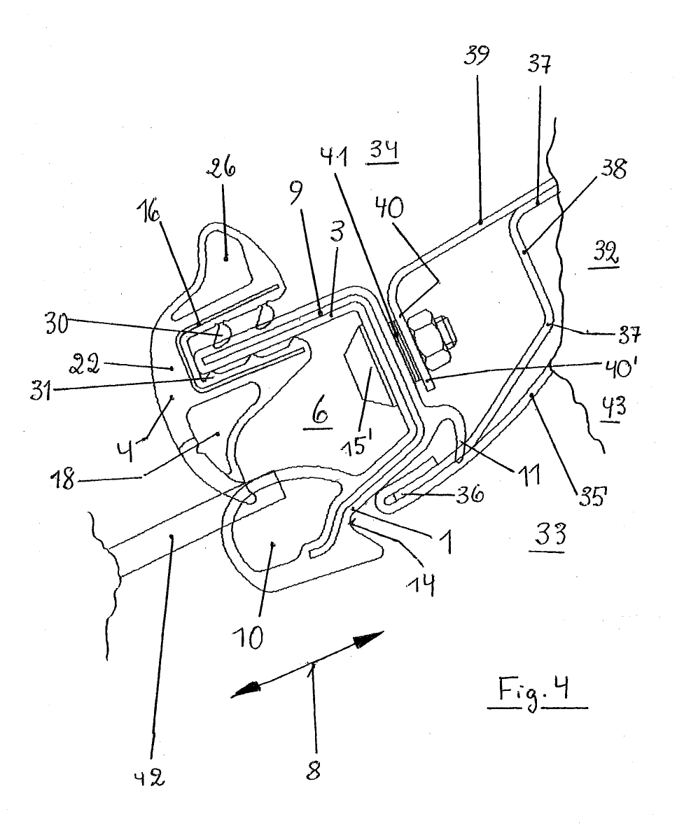

FIG. 4 shows a first illustration of a seal arrangement according to FIG. 1 in the installed state;

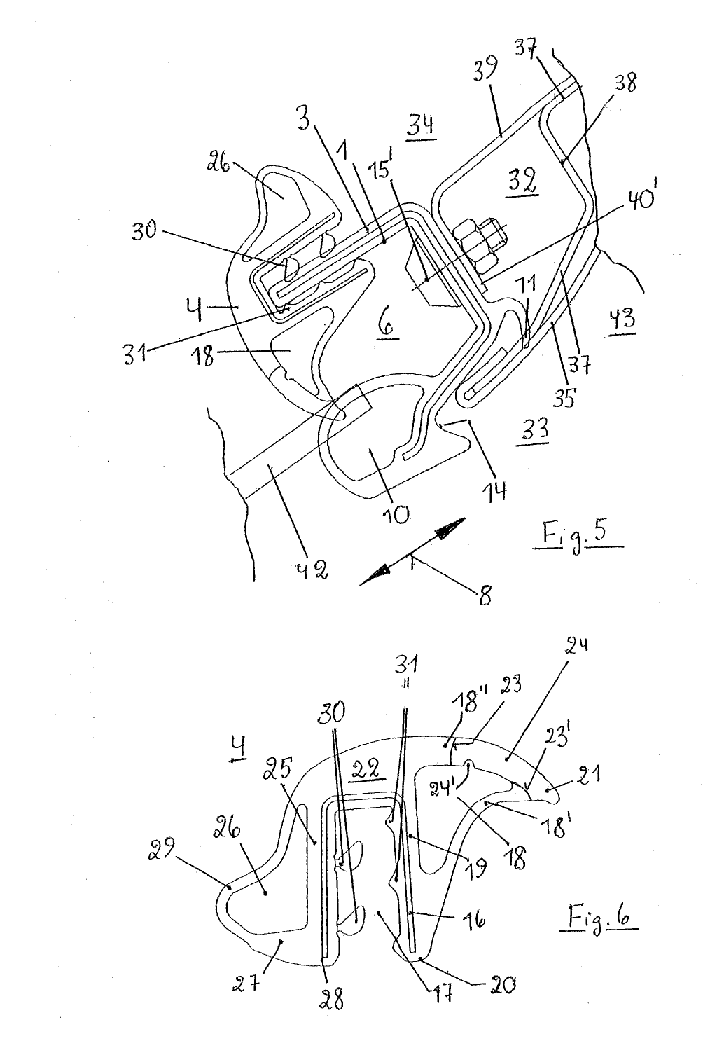

FIG. 5 shows a second illustration of a seal arrangement according to FIG. 1 in the installed state;

FIG. 6 shows an isolated illustration of an attachment profile, as part of the seal arrangement according to FIG. 1, in cross section.

In FIG. 1, 1 designates a substantially U-shaped reception profile which is intended to be mounted via its base side 2 on a body part. A likewise U-shaped attachment profile 4 is placed onto the leg 3 located on the left in the drawing and bears in the region of its base side 5 against the free end of the leg 3. The two components, to be precise the reception profile 1 and the attachment profile 4, form in the assembled state a seal arrangement according to the invention.

This seal arrangement circumscribes a reception space 6 which is open toward the top side 7 and into and out of which a pane of a vehicle window can be moved in the direction of the arrows 8 in a way yet to be described below.

To describe the two components of the seal arrangement, reference is additionally made below to FIGS. 2 and 3.

The reception profile 1 may consist entirely of soft rubber or TPE (Thermoplastic Elastomer), and its U-shaped part incorporates a reinforcement 9 which may consist of metal, for example steel or stainless steel, or of a hard thermoplastic, for example TPE. The reinforcement 9 extends along the U-shaped part. However, the latter profile may also consist entirely of EPDM (ethylene/propylene-diene terpolymer) provided with reinforcement, rubber materials in the form of microcellular rubber also coming into consideration. It is, in any event, an extrusion product.

The reception profile 1, on its side lying opposite the leg 3, specifically in the region of its open top side 7, forms a hollow profile part 10 which bulges in the direction of the leg 3. It is characterized by a relatively thin-walled wall portion 10′ which extends into the reception space 6 and which is completed by a relatively thicker-walled wall portion 10″, forming a lateral outer boundary of the reception profile 1, into a complete hollow profile 10. The reinforcement 9 extends partially into the wall portion 10″.

A sealing lip 11 extends adjacently to the base side 2 and, with that leg 12 of the attachment profile 3 which lies opposite the leg 3, surrounds a U-shaped cavity 13 open in the direction of the hollow profile part 10. The sealing lip 11 is intended to bear against the body parts of a vehicle in a way yet to be described below.

Integrally formed on the outside of the leg 12 or of the hollow profile part 10 is a channel 14 which is open in the direction of the cavity 13 and the significance of which will also be explained below.

15 designates a long hole which is formed into the base side 2 and which is intended for mounting the reception profile 1 on a body part and which, by virtue of its arrangement, affords possibilities for setting the mounting position in relation to the body part in the profile longitudinal direction. Long holes 15 of this type may be provided along said base part at uniform intervals in the profile longitudinal direction.

To describe the attachment profile 4, reference is additionally made below to drawing FIG. 6.

The attachment profile 4 has a U-shaped holding part 17 which is provided with a reinforcement 16 and which is intended to be attached onto the leg 3 of the reception profile 1. 18 designates a hollow profile part which is integrally formed onto the leg 19 located on the left in drawing FIG. 6, with the proviso that, in the assembled state of the seal arrangement, said hollow profile part lies opposite the hollow profile part 10 of the reception profile 1. This hollow profile part 18 consists of a relatively thin wall portion 18′ which extends from a region adjacent to the free end 20 of the leg 19 as far as the free end 21 of a relatively thicker wall portion 18″ integrally formed on the base side 22 of the holding part 17.

The wall portions 18′, 18″ together with the leg 19, form the hollow profile part 18. The two wall portions 18′, 18″ have a concave curvature in respect of the free end 20, an elastic deformability of the wall portion 18″ in the direction of said free end being afforded.

As indicated by the lines 23, 23′, a region 24 forming the free end of the wall portion 18″ may be formed from a material other than that of the remaining parts of the attachment profile 4. For example, this region 24 may be designed to be relatively softer than the remaining parts of this profile. The attachment profile 4 may consist basically of a soft rubber or TPE, while the region 24 may consist of microcellular rubber. The above-illustrated elastic deformation behavior of the region 24 may be influenced further by a notch 24′ which is located at that end of the region 24 which confronts the leg 19.

As shown in FIG. 1, the hollow profile parts 10, 18 form the outer termination of the reception space 6 in the assembled state of the seal arrangement. The significance of these hollow profile parts 10, 18 will be explained in more detail below. It is essential that, with the pane moved out of the reception space 6, the free end 21 bears under elastic prestress against the confronting side of the hollow profile part 10.

On the leg 25 which lies opposite the leg 19 and which together with the base side 22 forms a U-shaped profile, a further hollow profile part 26 is integrally formed. This consists of a relatively thick wall portion 27 which directly adjoins the free end 28 of the leg 25 and of a relatively thin wall portion 29 which with the leg 19 and the wall portion 27 completes the hollow profile part 26.

The elastic deformability of the hollow profile part 26 is determined mainly by the wall portion 29, and this hollow profile part 26 is designed as a cosmetic element of the interior design of a vehicle, said hollow profile part being intended to bear against an inside component, for example an inside roof lining. Instead of a hollow profile, a sealing lip or merely a bearing surface may also be present at this point. In the case of the hollow profile part 26, preferably the wall portion 29 of the latter comes to bear against said component.

30 designates holding webs which are integrally formed on the inside of the leg 25 and which, in the nonmounted state of the attachment profile 4, extend from the open side of the holding part 17 at an angle in the direction of the base side 22. Arranged opposite the holding webs 30, within the U-shaped space of the holding part 17, are profile elements 31 which, together with the holding webs 30, are intended and arranged so as to secure the attachment position of the attachment profile 4 and the leg 3 of the reception profile 1.

The visible parts of the attachment profile 4 and of the reception profile 1 may be covered with a laminating tape, not illustrated in the drawing, or with lacquer in order to improve the appearance.

To explain the installation of a seal arrangement according to the invention, reference is made below to the illustration in the drawing according to FIG. 4:

This illustration shows a body part 32, here part of a roof section of a vehicle, to which the seal arrangement is fastened, an outside of the vehicle being designated by 33 and an inside of the vehicle by 34. The body part is characterized by a panel 35 which confronts the outside 33 and around the free end 36 of which a further panel 37 is bent. The panel 37 is angled toward the inside 34 with respect to the panel 35 and, after an intermediate portion 38, extends parallel to an inside panel 39, at the same time bearing against the latter. The panel 39 extends essentially perpendicularly with respect to the intermediate portion 38 and with its free end 40 forms a mounting portion 40′ extending parallel to the intermediate portion 38 of the panel 35.

The reception profile 1 is screwed to this mounting portion 40′ by means of screws 15′ via the long holes 15 shown in FIG. 3, and therefore this portion 40′ is provided with a row of bores intended for this purpose. Screwing takes place with the interposition of washers 41, by means of which an adjustability of the mounting position of the reception profile 1 with respect to the mounting portion 40′ in the direction of the arrows 8 is afforded. On account of said long holes, adjustment perpendicular to the drawing plane of FIG. 4 is possible.

After the mounting of the reception profile 1 on the mounting portion 40′ in a desired position has taken place, the attachment profile 4 is attached onto the leg 3, specifically with the proviso that the hollow profile part 18 extends in the direction of the hollow profile part 10 of the reception profile 1. The mutually confronting portions of the two hollow profile portions 10, 18 bear under elastic pretension one against the other and close the open end of the reception space 6.

42 designates a vehicle windowpane which is held displaceable in a way known per se between an opening and a closing position in the direction of the arrows 8. It can be seen that, in the closed state, the pane 42 can be introduced into the reception space 6, with the confronting sides of the hollow profile parts 10, 18 being displaced elastically, so that, in this position, said sides bear sealingly against the pane 42.

An illustration of such a structural part of the roof section, against which structural part the hollow profile part 26 bears under elastic deformation, has been dispensed with for the sake of clarity in the drawing.

It can be seen that the seal arrangement according to the invention forms, by virtue of the fastening outlined above, a channel 14 which is open toward the top side 43 and which is intended for the ordered diversion of impinging rainwater. It can be seen, further, that, in the mounted state, the sealing lip 11 bears under elastic deformation against the inside, confronting it, of the panel 37, so that moisture is reliably prevented from penetrating into the body part 32 from outside.

It can be seen, finally, that the attachment position of the attachment profile 4 on the leg 3 is secured reliably as a result of the elastic bracing of the holding webs 30 in conjunction with the profile elements 31. On the other hand, by virtue of this two-part design of a seal arrangement, if required, a simple demounting of a damaged attachment profile 4 and replacement by an undamaged profile part are possible.

Both profiles of the seal arrangement may be produced from the same material and by virtue of their structure have, in conjunction with the reinforcements used, a sufficient rigidity which ensures a reliable fit in the installed state.

FIG. 5 shows a mounting position of the seal arrangement, in which no washers 41 are used, so that its adjustment takes place solely perpendicularly to the drawing plane by means of the long holes 15 (FIG. 3) already mentioned initially. Otherwise, the same reference numerals have been used for identical functional elements, and therefore a repeated description may to that extent be dispensed with.

1. A seal arrangement for bordering a vehicle aperture, in particular a window, in which a pane (42) is guided slideably between an opening and a closing position, with a reception profile (1) of U-shaped cross section, which is intended to be fastened directly to body parts and which is connected releasably to an attachment profile (4) having a U-shaped holding part (17), in the assembled state the reception profile (1) and the attachment profile (4) surrounding a U-shaped reception space (6) receiving the pane (42) in the closed state, the reception space (6) having structural elements which, in the closed state, bear sealingly on both sides against the pane (42), characterized in that the reception profile (1) is designed to be fastened to body parts via the base side of its cross section and forms an open top side (7), in that the holding part (17) of the attachment profile (4) is intended and designed to be attached onto one leg (3) of the reception profile (1), in that said structural elements are formed by hollow profile parts (10, 18) which are formed, in the region of the top side (7), on the reception profile (1) and on the one leg (19) of the attachment profile (4), so as to lie opposite one another and to extend into the reception space (6), and in that the attachment profile (4) can be mounted and demounted independently of the reception profile (1).

2. The seal arrangement as claimed in claim 1, characterized in that the reception profile (1) consists of an elastomer which is strengthened by means of a reinforcement (9), and in that the reinforcement (9) preferably extends along the whole of the U-shaped cross section of said reception profile.

3. The seal arrangement as claimed in claim 1, characterized in that the attachment profile (4) consists of an elastomer and is strengthened by means of a reinforcement (16) which preferably extends along the whole of the cross section of a holding part (17) intended for fastening the attachment profile (4) to the reception profile (1).

4. The seal arrangement as claimed in claim 1, characterized in that the reception profile (1) is intended to be screwed via the base side (2) of its cross section to a mounting portion of a body part.

5. The seal arrangement as claimed in claim 1, characterized in that those portions of the hollow profile parts (10, 18) which are intended for bearing against the pane (42) carry friction-reducing and/or wear-reducing coatings.

6. The seal arrangement as claimed in claim 1, characterized in that those portions of the hollow profile parts (10, 18) which are intended for bearing against the pane (42), on the one hand, and the remaining portions of the attachment profile (4) and of the reception profile (1), on the other hand, are produced from different materials, a relatively softer material being used in the first-mentioned portions and a relatively harder material being used in the last-mentioned portions.

7. The seal arrangement as claimed in claim 1, characterized in that the holding part (17) is intended and designed to be attached onto that leg (3) of the reception profile (1) which, in the mounted state in a vehicle, confronts the inside (34) of the latter.

8. The seal arrangement as claimed in claim 1, characterized in that a channel (14) is integrally formed on the outside on that leg (12) of the reception profile (1) which, in the mounted state in a vehicle, confronts the outside (33) of the latter.

9. The seal arrangement as claimed in claim 1, characterized in that a sealing lip (11) intended for cooperating with body parts is integrally formed on the outside on that leg (12) of the reception profile (1) which, in the mounted state in a vehicle, confronts the outside (33) of the latter.

10. The seal arrangement as claimed in claim 1, characterized in that a further hollow profile part (26), which is intended for bearing against inside components of the vehicle, is integrally formed on that side of the attachment profile (4) which, in the mounted state, confronts the inside (34) of the vehicle.

11. The seal arrangement as claimed in claim 1, characterized in that elastically deformable retention elements are integrally formed on the inside of the holding part (17) and are intended for cooperating with the leg (3) of the reception profile (1).

12. The seal arrangement as claimed in claim 1, characterized in that the hollow profile parts (10, 18) projecting into the reception space (6) are designed so as to be structured in the circumferential region with a view to providing a defined elastic deformation behavior.

13. The seal arrangement as claimed in claim 2, characterized in that the attachment profile (4) consists of an elastomer and is strengthened by means of a reinforcement (16) which preferably extends along the whole of the cross section of a holding part (17) intended for fastening the attachment profile (4) to the reception profile (1).

14. The seal arrangement as claimed in claim 2, characterized in that the reception profile (1) is intended to be screwed via the base side (2) of its cross section to a mounting portion of a body part.

15. The seal arrangement as claimed in claim 3, characterized in that the reception profile (1) is intended to be screwed via the base side (2) of its cross section to a mounting portion of a body part.

16. The seal arrangement as claimed in claim 2, characterized in that those portions of the hollow profile parts (10, 18) which are intended for bearing against the pane (42) carry friction-reducing and/or wear-reducing coatings.

17. The seal arrangement as claimed in claim 3, characterized in that those portions of the hollow profile parts (10, 18) which are intended for bearing against the pane (42) carry friction-reducing and/or wear-reducing coatings.

18. The seal arrangement as claimed in claim 4 characterized in that those portions of the hollow profile parts (10, 18) which are intended for bearing against the pane (42) carry friction-reducing and/or wear-reducing coatings.

19. The seal arrangement as claimed in claim 2, characterized in that those portions of the hollow profile parts (10, 18) which are intended for bearing against the pane (42), on the one hand, and the remaining portions of the attachment profile (4) and of the reception profile (1), on the other hand, are produced from different materials, a relatively softer material being used in the first-mentioned portions and a relatively harder material being used in the last-mentioned portions.

20. The seal arrangement as claimed in claim 3, characterized in that those portions of the hollow profile parts (10, 18) which are intended for bearing against the pane (42), on the one hand, and the remaining portions of the attachment profile (4) and of the reception profile (1), on the other hand, are produced from different materials, a relatively softer material being used in the first-mentioned portions and a relatively harder material being used in the last-mentioned portions.
